(19) United States
(12) Patent Application Publication
(10) Pub. No.: US 2024/0249431 A1
(43) Pub. Date: Jul. 25, 2024

(54) METHOD FOR ESTIMATING GAZE DIRECTIONS OF MULTIPLE PERSONS IN IMAGES

(71) Applicant: Beihang University, Beijing (CN)

(72) Inventors: Feng LU, Beijing (CN); Yunfei LIU, Beijing (CN)

(21) Appl. No.: 18/597,369

(22) Filed: Mar. 6, 2024

(30) Foreign Application Priority Data
Mar. 7, 2023 (CN) 2023102166797

(51) Int. Cl. G06T 7/73; G06N 3/08; G06V 10/776; G06V 10/82; G06V 40/16

(52) U.S. Cl. CPC G06T 7/73; G06N 3/08; G06V 10/776; G06V 10/82; G06V 40/169; G06T 2207/20081; G06T 2207/20084; G06T 2207/30201

(57) ABSTRACT

The embodiments of the present disclosure disclose a method for estimating the gaze directions of multiple persons in images, including: a novel method for estimating the gaze directions of multiple persons in images, being able to predict the gaze direction of a single or multiple face regions in an image accurately and in real-time; a novel multi-task learning network structure, which simultaneously predict the gaze directions of multiple face regions in the image through one-time calculation; a self-supervised loss function based on two-dimensional projection, which be used to supervise three-dimensional gaze direction estimation; a novel method for generating gaze direction replacement data of multiple face regions, being able to quickly generate a large amount of labeled realistic data, for training and testing of a deep learning model; the proposed network is trained end-to-end on the constructed data, then the model can predict the gaze direction in real-time during deployment testing.

### CROSS-REFERENCE TO RELATED APPLICATION

The present application is based on, and claims priority from, Chinese application number 2023102166797, filed on Mar. 7, 2023, the disclosure of which is hereby incorporated by reference herein in its entirety.

### TECHNICAL FIELD

The present disclosure relates to the field of computer vision and image processing, and in particular, to a method for estimating the gaze directions of multiple persons in images.

### BACKGROUND

The human gaze direction is an important channel for expressing intentions, and has noteworthy applications in such fields as human-computer interaction, virtual and augmented reality, and so on. Using facial images to calculate the gaze direction is currently a hot research topic, but existing methods usually assume that the input image only contains one cropped and calibrated face. If there are multiple target characters in the application scenario, there will be no way to calculate the gaze directions of multiple persons at real-time speed. Regarding this issue, the goal of the present technique is to simultaneously estimate the gaze directions of multiple target characters in images through one single calculation, and ultimately achieve real-time estimation of the gaze directions of multiple persons in the video.

### SUMMARY

The content of the present disclosure is to briefly introduce the concepts, which will be described in detail in the section of detailed description of the invention later. The content of this disclosure is not intended to identify key or necessary features of the claimed technical solution, nor is it intended to limit the scope of the claimed technical solution.

At present, gaze direction estimation based on appearance is a hot research topic, and people have applied various strategies to improve estimation accuracy, such as coarse-to-fine estimation strategies, adversarial learning methods, and self-attention mechanisms, and so on. At the same time, multiple large-scale gaze estimation image datasets have been published. Most of the images were collected in a laboratory environment with strict multi-view camera settings, participants in fixed positions, and targets to be gazed at. This type of collecting process usually results in these datasets containing only single-face images in limited scenarios. Correspondingly, the gaze estimation methods already proposed assume that there is only one calibrated face in the input image. However, this will lead to a drawback, that is, the speed of the current gaze direction estimation method is proportional to the number of faces in the input image. When there are multiple persons in the image, most methods cannot process the video data at real-time speed.

The task of understanding facial images has received great attention due to its widespread applications. Many practical methods such as human face location, facial expression recognition, and head posture estimation etc. have been proposed. With the research development of object detection methods, one-time calculating methods for multi-face parallel calculations are favored in real-time applications due to their lightweight design and high accuracy. For example, the new face detection method applies a single-stage structure and designs more effective modules for facial features. At the same time, a plurality of corresponding large-scale facial datasets have also been published, many of which are constructed through extensive manual annotations. In addition, it has been found that multi-task learning (estimation of facial key points, head posture, gender, etc.) while conducting face detection is an efficient method, because the calculations of these tasks all rely on common facial features. The technique in this article is inspired by these works and aims to develop a face-based one-time calculating method for gaze direction estimation.

Based on the above practical demands and technical difficulties, the purpose of the present disclosure consists in: a novel method for one-time calculating the gaze directions of multiple face regions, being able to predict the gaze direction of a single or multiple face regions in an image accurately and in real-time; a novel method for generating multi-person gaze direction replacement data, being able to quickly generate a large amount of labeled realistic data, for training and testing of a deep learning model; based on the generated dataset, a novel multi-task learning network structure is proposed, which can simultaneously predict the gaze directions of multiple face regions in the image through one-time calculation and support end-to-end training; a self-supervised loss function based on two-dimensional projection may be used to supervise three-dimensional gaze direction estimation and improve calculation accuracy.

Some embodiments of the present disclosure provide a method for determining gaze directions of multiple persons in images, which comprises: obtaining a facial image, wherein the facial image includes at least one face region; constructing a deep network model for multi-task learning, wherein the deep network model includes a plurality of multi-task processing structures capable of parallel calculations, the plurality of multi-task processing structures capable of parallel calculations output the gaze direction of each face region and the face position information of each face region in the facial image through one-time calculation; training the deep network model end-to-end on the dataset to obtain a trained deep network model, wherein the trained deep network model is used to determine the gaze directions of multiple persons; inputting the facial image to the trained deep network model to obtain the gaze direction of at least one face region included in the facial image.

The method for determining the gaze directions of multiple face regions in images disclosed by the present disclosure has the following beneficial features compared to other gaze direction estimation methods: (1) a novel method for one-time calculating the gaze directions of multiple face regions is invented, its operating speed is not affected by the number of faces in the image and can predict the gaze direction of a single or multiple face regions in the image accurately and in real-time; (2) a novel multi-task learning network structure is designed, which can simultaneously predict the gaze directions of multiple face regions in the image by processing the image once, as well as at the same predict information such as face position and head posture etc.; (3) a novel self-supervised loss function based on two-dimensional projection is proposed, which can pertinently supervise the estimation of three-dimensional gaze direction and improve calculation accuracy; (4) a novel method for generating gaze direction replacement data for multiple face regions is designed, which can quickly generate a large amount of labeled realistic data for training and testing of a deep learning model; (5) the proposed network can be trained end-to-end on the constructed data, then the model accurately predicts the gaze direction in real-time during deployment testing.

### BRIEF DESCRIPTION OF THE DRAWINGS

The above and other features, advantages, and aspects of the embodiments of the present disclosure will become more apparent in conjunction with the accompanying drawings and with reference to the following specific implementations. Throughout the drawings, the same or similar reference signs indicate the same or similar elements. It should be understood that the drawings are schematic, and the components and elements are not necessarily drawn to scale.

FIG. 1 is a flowchart of some embodiments of a multi-person gaze direction estimation method in mages according to the present disclosure;

FIG. 2 is a flowchart of some other embodiments of a multi-person gaze direction estimation method in mages according to the present disclosure;

FIG. 3 is a schematic diagram of a facial image of a multi-person gaze direction estimation method in mages according to some embodiments of the present disclosure;

FIG. 4 is a schematic diagram of a dataset construction and generation framework for a multi-person gaze direction estimation method in mages according to some embodiments of the present disclosure;

FIG. 5 is a schematic diagram of a deep network model for a multi-person gaze direction estimation method in mages according to some embodiments of the present disclosure;

FIG. 6 is a schematic diagram of a projection-based self-supervised loss function for a multi-person gaze direction estimation method in mages according to some embodiments of the present disclosure;

FIG. 7 is a schematic diagram of a gaze direction of the face region for a multi-person gaze direction estimation method in mages according to some embodiments of the present disclosure.

### DETAILED DESCRIPTION OF THE DISCLOSURE

Hereinafter, the embodiments of the present disclosure will be described in more detail with reference to the accompanying drawings. Although certain embodiments of the present disclosure are shown in the drawings, it should be understood that the present disclosure may be implemented in various forms, and shall not be construed as being limited to the embodiments set forth herein. On the contrary, these embodiments are provided for a more thorough and complete understanding of the present disclosure. It should be understood that the drawings and embodiments of the present disclosure are used only for illustrative purposes, not to limit the protection scope of the present disclosure.

Besides, it should be noted that, for ease of description, only the portions related to the relevant invention are shown in the drawings. In the case of no conflict, the embodiments in the present disclosure and the features in the embodiments may be combined with each other.

It should be noted that such adjuncts as “one” and “more” mentioned in the present disclosure are illustrative, not restrictive, and those skilled in the art should understand that, unless the context clearly indicates otherwise, they should be understood as “one or more”.

The present disclosure will be described in detail below with reference to the accompanying drawings and in conjunction with embodiments.

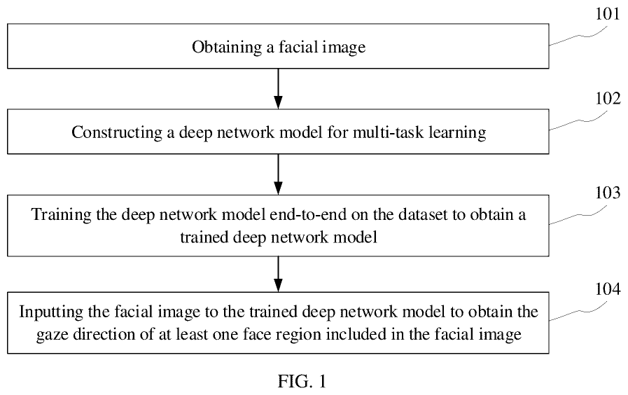

FIG. 1 is a flowchart of some embodiments of a multi-person gaze direction estimation method in mages according to the present disclosure. The multi-person gaze direction estimation method in mages comprises the following steps:

Step 101, obtaining a facial image.

In some embodiments, the executing body of the multi-person gaze direction estimation method in mages may obtain a facial image through wired or wireless connections. Wherein, the facial image includes at least one face region.

Optionally, the face region in the at least one face region may include but not be limited to at least one of the following: facial size information, posture information, facial expression information, and gender information.

Step 102, constructing a deep network model for multi-task learning.

In some embodiments, the executing body mentioned above may construct a deep network model for multi-task learning. Wherein, the deep network model includes a plurality of multi-task processing structures capable of parallel calculations. The plurality of multi-task processing structures capable of parallel calculations output the gaze direction of each face region and the face position information of each face region in the facial image, through one-time calculation.

Optionally, the deep network model is a multi-task single-stage deep network model, which includes one encoder and multiple decoders. Wherein, the decoders in the multiple decoders are decoders that simultaneously complete different types of tasks. The deep network model is used to determine at the same time the gaze directions of multiple face regions, and output face position information and key point information of multiple face regions.

Step 103, training the deep network model end-to-end on the dataset to obtain a trained deep network model.

In some embodiments, the executing body may train the deep network model end-to-end on the dataset to obtain a trained deep network model. Wherein, the trained deep network model is used to determine the gaze directions of multiple persons.

Optionally, the above dataset is generated by a multi-person gaze direction image and generation framework that has replaced the eye region, by inputting two types of data. Wherein, one type of data is single-person image data with a gaze direction label, and the other type of data is multi-person image data with multiple face regions. The generation framework is used to automatically cluster single-person image data based on at least one of the gender information, race information, age information and head posture information, for easy retrieval. The generation framework is also used to retrieve in the single-person image data, single-person image data that is closest to the aforementioned face region, for each face region in the multi-person image data, and replace the eye region, to generate a corresponding gaze direction.

Optionally, the overall loss function during end-to-end training process may be obtained by the following formula:

$$L = α {L}_{face} + β {L}_{gaze} .$$

Wherein, L represents the overall loss function. α represents the first adjustable hyperparameter. L_{face} represents the loss function related to face position information and key point information. β represents the second adjustable hyperparameter. L_{gaze} represents the loss function related to the gaze direction. Wherein, the first adjustable hyperparameter and the second adjustable hyperparameter may be set according to actual needs.

Wherein, L_{gaze} may be obtained by the following formula:

$${L}_{gaze} = {λ}_{1} {L}_{self} + {λ}_{2} {\vert {y}_{g} - {y}_{g}^{*} \vert}_{1} .$$

Wherein, L_{gaze} represents the loss function related to the gaze direction. λ₁ represents the first hyperparameter used to balance different loss terms. L_{self} represents the self-supervised loss function. λ₂ represents the second hyperparameter used to balance different loss terms. y_{g} represents the gaze direction of the face region. y_{g}* represents the truth label. ∥₁ represents the L1 norm. Wherein, the first hyperparameter used to balance different loss terms and the second hyperparameter used to balance different loss terms may be set according to actual needs.

Step 104, inputting the facial image to the trained deep network model to obtain the gaze direction of at least one face region included in the facial image.

In some embodiments, the executing body may input the facial image in real-time to the trained deep network model, in a deployment environment, to accurately obtain the gaze direction of at least one face region included in the facial image once.

Optionally, the above method may also comprise: for the gaze direction of each face region in the gaze direction of the above at least one face region, the following determination steps may be performed:

The first step is to determine the positions y_{F},y_{T},y_{S} of the gaze projection points of the gaze direction y_{g}=(θ,ψ) of the above face region on the front, top and side projection planes. Wherein, y_{F} represents the position of the gaze projection point in the front direction. y_{T} represents the position of the gaze projection point in the top direction. y_{S} represents the position of the gaze projection point in the side direction. F represents the front direction. T represents the top direction. S represents the side direction. y_{g} represents the gaze direction of the face region mentioned above. θ represents the angle of nutation in the gaze direction. ψ represents the angle of rotation in the gaze direction.

The second step is to determine whether the positions y_{F},y_{T},y_{S} of the gaze projection points on the front, top and side projection planes are equal to the three projections of the three-dimensional gaze prediction values. Wherein, the three projections of the three-dimensional gaze prediction values may be obtained by the following formula:

$$\{ \begin{matrix}{\prod }_{F} ( θ , ϕ ) = [ sin ϕcosθ , sin θ ] \\ {\prod }_{T} ( θ , ϕ ) = [ cos ϕcosθ , sin ϕcosθ ] \\ {\prod }_{S} ( θ , ϕ ) = [ cos ϕcosθ , sin θ ]\end{matrix} .$$

Wherein, Π represents the projection function. F represents the front direction. θ represents the angle of nutation in the gaze direction. ϕ represents the angle of rotation in the gaze direction. Π_{F}(θ,ϕ) represents projecting the gaze direction onto the front plane. sin ϕ represents the sine value of ϕ. cos θ represents the cosine value of θ. T represents the top direction. Π_{T}(θ,ϕ) represents projecting the gaze direction onto the top plane. cos ϕ represents the cosine value of ϕ. S represents the side direction. Π_{S}(θ,ϕ) represents projecting the gaze direction onto the side plane. sin θ represents the sine value of 0.

Optionally, the above deep network model includes a self-supervised loss function, which is obtained by the following formula:

$${L}_{self} = {\sum }_{τ ∈ \{ F , T , S \}} {\vert {y}_{τ} - {\prod }_{τ} ( {y}_{g} ) \vert}_{1} \times {e}_{τ}^{- p} + {p}_{τ} .$$

Wherein, L_{self} represents the self-supervised loss function. τ represents the front or top or side direction. τ takes the value of {F,T,S}. F represents the front direction. T represents the top direction. S represents the side direction. y_{τ} represents the gaze direction in the front or top or side direction. Π represents the projection function. y_{g} represents the gaze direction of the face region. Π_{τ}(y_{g}) represents the projection function from three-dimension to two-dimension. ∥₁ represents the L1 norm. e represents a natural constant. p represents a trainable parameter. e_{τ}^{-p} represents the −p power of e. p_{τ} represents the correction coefficient for τ projection.

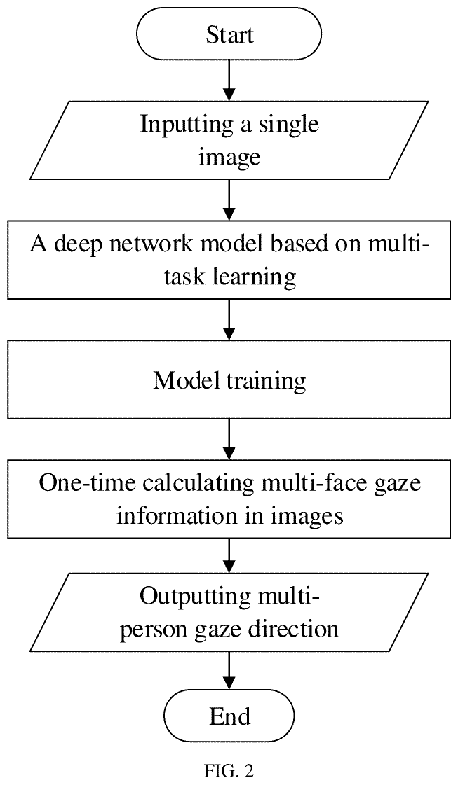

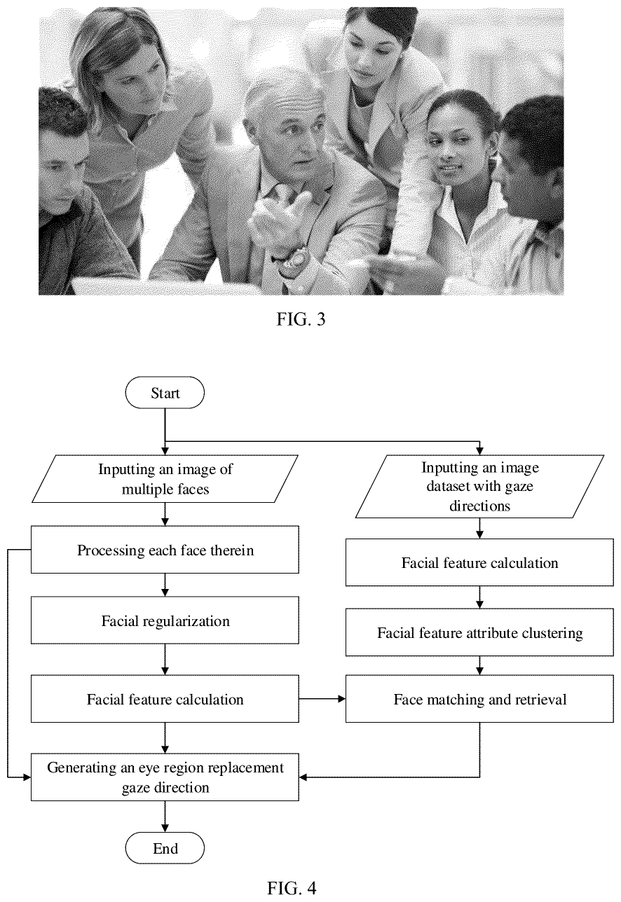

See FIG. 2, the basic operation of the multi-person gaze direction estimation method in images of the present disclosure is to input a facial image with a single or multiple face regions. As shown in FIG. 3, there is no restriction on the head posture information, facial expression information, gender information, age information, etc. of each person in the image. The output is each person's gaze direction, as shown in FIG. 7, and each person's gaze direction is represented by an arrow of a unit vector at the center of the eyebrow.

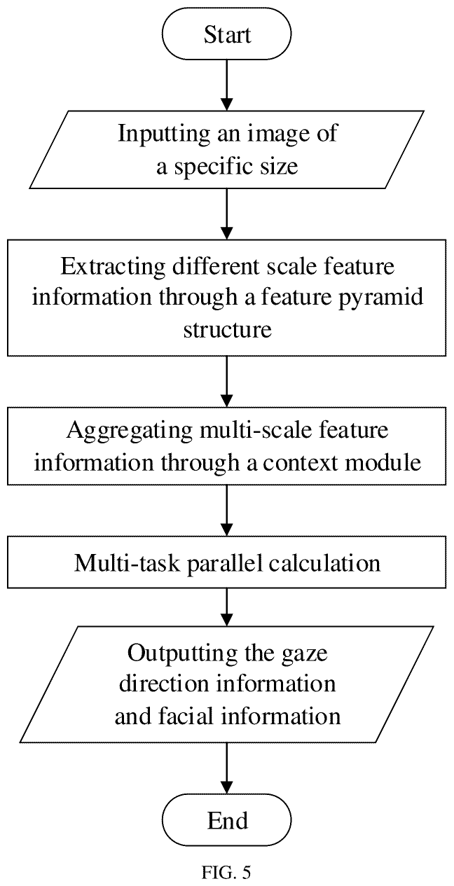

The system operation flowchart in the present disclosure is shown in FIG. 2, which includes: inputting a single image, a deep network model based on multi-task learning, model training, one-time calculating of multiple facial gaze information in the image, and outputting multi-person gaze directions. Wherein:
(1) During the training process, image fusion is performed on a single-person image dataset with gaze direction labels and a multi-person image dataset without gaze directions, to construct a dataset of multi-person images with gaze direction labels simultaneously.
(2) The image fusion process is shown in FIG. 4. Firstly, input an image containing multiple faces, here the faces may be face regions. Then, process each face therein, then perform facial regularization and facial feature calculation. At the same time, input an image dataset with gaze directions, perform facial feature calculation, then cluster facial feature attributes. Thereafter, perform face matching and retrieval on the result of performing facial feature calculation on the input image containing multiple faces, together with the result of clustering of facial feature attributes, to finally generate an eye region replacement gaze direction. Therefore, by inputting an image containing multiple target tasks and a dataset with gaze direction labels, constructing a dataset containing not only multiple target characters but also corresponding gaze direction truth labels, thus merging the advantages of the face dataset and the gaze dataset.
(3) Design a single-stage multi-task neural network model framework using the data generated in (2) as the training set. The process of the model framework is shown in FIG. 5, which includes inputting an image of a specific size, extracting different scale feature information through a feature pyramid structure, aggregating multi-scale feature information through a context module, multi-task parallel calculating, and outputting the gaze direction information and facial information. The input of this model is a complete image containing any number of face regions, and the output is the three-dimensional gaze direction of each detected face region. Wherein, the model can be trained end-to-end on the training set.
(4) During the testing process, input an initial image, the input initial image is as shown in FIG. 3. At the same time, the image may be scaled to a specific size.
(5) Input the image scaled in (4) to the deep network model trained in (3) for testing, obtain such information as the gaze direction and face position of the target face region in the image, and visualize the obtained results in the input image, as shown in FIG. 7.

The specific contents of the innovations made in the various steps are explained in combination with relevant attached drawings as follows:

### Innovation Point (1) a Method for Estimating the Gaze Directions of Multiple Persons by One-Time Calculation

The present disclosure adopts a method for estimating the gazes of multiple persons by one-time calculation. Unlike other gaze estimation models that process face regions one by one, this model is the first model that estimates the gazes of multiple persons through one-time calculation. This model may accurately estimate the gaze directions of multiple target objects in the image in real-time during the testing process.

### Innovation Point (2) a Deep Neural Network Structure Based on Multi-Task Learning

Firstly, for the input image, as shown in FIG. 3, the network outputs the gaze directions of multiple objects in the image through multi-task learning during the training process, the visualization results are shown in FIG. 7. As shown in FIG. 5, the network structure mainly consists of three parts: a multi-scale feature extraction module, an information aggregation module, and a multi-task parallel processing module, respectively. During the training process, the deep neural network undergoes end-to-end training on the constructed dataset.

To be specific, the multi-scale feature extraction module may be realized through a feature pyramid structure during the implementation process. The extracted features are calculated using top-down and lateral connections for the outputs of the deeply separable convolutional MobileNet model or residual network ResNet at different stages. The feature pyramid structure includes two modules, namely a bottom-up feature extraction module and a top-down feature aggregation module. In the bottom-up process, features are extracted from the image by a multi-stage convolutional module. Then, feature aggregation is carried out through the feature aggregation module. For the output of each feature layer, this technique adds a context module to increase receptive fields. By doing so, rich semantic information features are extracted from the image, and faces of different dimensions may be processed equally.

After feature extraction, use 1×1 convolution in the multi-task parallel processing module as calculation for different downstream tasks. For face detection tasks, use three calculation modules during the implementation process: classification module, positioning module, and key point module, which are respectively used to estimate the possibility yₚ of face existence, the position y_{b} of the face region, and the position yₗ of facial key points. This technique also includes a three-dimensional gaze estimation module for calculating y_{g}, and three additional two-dimensional gaze projection point estimation modules for calculating y_{F},y_{T}, y_{S}. For each training anchor box i, the goal of this technique is to minimize the loss to L=αL_{face}+βL_{gaze}. Wherein, L represents the overall loss function. α represents the first adjustable hyperparameter. L_{face} represents the loss function related to face position information and key point information. β represents the second adjustable hyperparameter. L_{gaze} represents the loss function related to the gaze direction. Wherein, L_{face}=L_{class}(yₚⁱ,yₚⁱ*)+λ₁yₚⁱ*L_{box}(y_{b}ⁱ,y_{b}ⁱ*)+λ₂yₚⁱ*L_{landmark}(yₗⁱ,yₗⁱ*). Wherein, L_{face} represents the loss function related to face position information and key point information. L_{class} represents the loss function used for classification. i represents the training anchor box. yₚⁱ represents the possibility of presence of the i^{th} face. yₚⁱ* represents the possibility of presence of the i^{th} face labeled in the dataset. λ₁ represents the first hyperparameter used to balance different loss terms. L_{box} represents. y_{b}ⁱ represents the position of the i^{th} face region. y_{b}ⁱ* represents the position of the i^{th} face region labeled in the dataset. λ₂ represents the second hyperparameter used to balance different loss terms. L_{landmark} represents the loss function used to calculate key points. yₗⁱ represents the position of the i^{th} facial key point predicted by the network. yₗⁱ* represents the position of the i^{th} facial key point labeled in the dataset.

### Innovation Point (3) a Projection-Based Self-Supervised Loss Function

The present disclosure designs a novel projection-based self-supervised loss function that may improve the prediction accuracy of the gaze direction. The loss function is L_{gaze}, the L_{gaze} definition may be:

$${L}_{gaze} = {λ}_{1} {L}_{self} + {λ}_{2} {\vert {y}_{g} - {y}_{g}^{*} \vert}_{1} .$$

Wherein, L_{gaze} represents the loss function related to the gaze direction. λ₁ represents the first hyperparameter used to balance different loss terms. L_{self} represents the self-supervised loss function, λ₂ represents the second hyperparameter used to balance different loss terms. y_{g} represents the gaze direction of the face region. y_{g}* represents the truth label. ∥₁ represents the L1 norm.

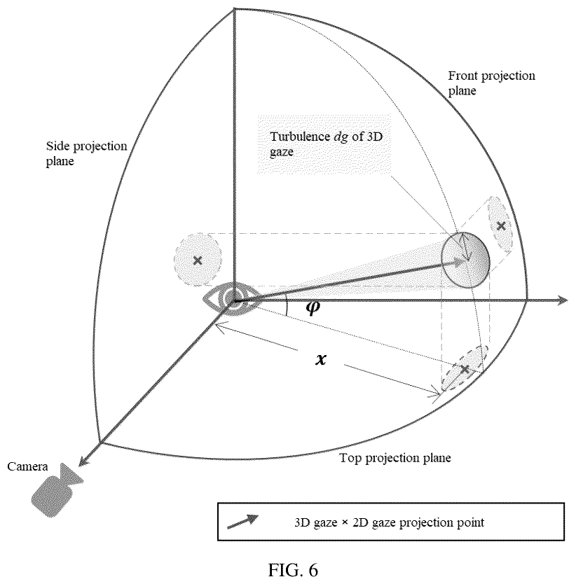

Here, L_{self} is a projection-based self-supervised loss designed for three-dimensional gaze direction. To be specific, as shown in FIG. 6, this technique proposes to project the three-dimensional gaze direction onto three planes, namely the front, side, and top, to form three two-dimensional gaze projection points, using the calculation of the positions of the three two-dimensional points as the subtask to form self-supervision and enhance the accuracy of the three-dimensional gaze direction calculation. In the mathematical sense, this technique introduces the concept of two-dimensional gaze sensitivity (GS):

$$GS = \frac{dg}{dx} = \frac{d φ}{dx} = \frac{r}{\sqrt{{r}^{2} - {x}^{2}}} .$$

Wherein, GS represents the two-dimensional gaze sensitivity. g represents the three-dimensional gaze direction. x represents the projection of the gaze in the image coordinate system. dg/dx represents the projection ratio of the two gazes, g and x. φ represents the angle of rotation. dφ/dx represents the ratio of φ to x. r represents the radius of the unit circle.

The two-dimensional gaze sensitivity defines the rate of change of x caused by a change in g, and this formula indicates that the farther the position of x from the origin, the greater the sensitivity GS will be. At the implementation level, the objective function of gaze direction estimation not only predicts the three-dimensional gaze direction, but also calculates the positions of gaze projection points on the three projection planes, i.e. y_{F},y_{T},y_{S}. The calculation method is as the following formula:

$$\{ \begin{matrix}{\prod }_{F} ( θ , ϕ ) = [ sin ϕcosθ , sin θ ] \\ {\prod }_{T} ( θ , ϕ ) = [ cos ϕcosθ , sin ϕcosθ ] \\ {\prod }_{S} ( θ , ϕ ) = [ cos ϕcosθ , sin θ ]\end{matrix} .$$

Wherein, Π represents the projection function. F represents the front direction. θ represents the angle of nutation in the gaze direction. ϕ represents the angle of rotation in the gaze direction. Π_{F}(θ,ϕ) represents projecting the gaze direction onto the front plane. sin ϕ represents the sine value of ϕ. cos θ represents the cosine value of θ. T represents the top direction. Π_{T}(θ,ϕ) represents projecting the gaze direction onto the top plane. cos ϕ represents the cosine value of ϕ. S represents the side direction. Π_{S}(δ,ϕ) represents projecting the gaze direction onto the side plane. sin θ represents the sine value of θ.

By limiting the positions y_{F},y_{T},y_{S} of three two-dimensional gaze projection points to be the same as the projection position of the three-dimensional gaze prediction value y_{g}, the implementation method may be achieved by the following loss function:

$${L}_{self} = {\sum }_{τ ∈ \{ F , T , S \}} {\vert {y}_{τ} - {\prod }_{τ} ( {y}_{g} ) \vert}_{1} \times {e}_{τ}^{- p} + {p}_{τ} .$$

Wherein, L_{self} represents the self-supervised loss function. τ represents the front or top or side direction. τ takes the value of {F,T,S}. F represents the front direction. T represents the top direction. S represents the side direction. y_{τ} represents the gaze direction in the front or top or side direction. Π represents the projection function. y_{g} represents the gaze direction of the face region. Π_{τ}(y_{g}) represents the projection function from three-dimension to two-dimension. ∥₁ represents the L1 norm. e represents a natural constant. p represents a trainable parameter. e_{τ}^{-p} represents the −p power of e. p_{τ} represents the correction coefficient for r projection.

### Innovation Point (4) Multi-Person Gaze Direction Replacement Data Generation

In innovation point (2), a new multi-person gaze replacement process framework is proposed. The existing dataset either only contains facial information (such as bounding boxes, key points, etc.), or only contains a calibrated single face with gaze direction labels. Therefore, the first challenge faced by this technique is to construct a dataset that includes both multiple target characters and corresponding gaze direction truth labels, thereby merging the advantages of both the face dataset and the gaze dataset. The framework of this process is shown in FIG. 4. During the implementation process, in order to synthesize a multi-person gaze replacement dataset, the present disclosure chooses the existing largest and most common gaze dataset ETH-XGaze, as well as the face detection dataset Widerface.

Firstly, perform facial attribute calculations for each suitable face in Widerface and ETH-XGaze:

$$A = F ( I ) .$$

Wherein, A represents the set of facial attributes calculated from the input image. F represents a feature extractor. I represents the input image.

Wherein, A is a set of facial attributes calculated from a single-face image, including facial key point information, head posture information, age information, gender information, and race information.

Next, for the appropriate face f_{w}, in each Widerface dataset, retrieve the closest face in ETH-XGaze. During the retrieval process, guide the retrieval results by using a scoring formula. The scoring formula is as follows:

$$S ( {f}_{e} , {f}_{w} ) = {\sum }_{τ ∈ \{ key point , head posture \}} {α}_{τ} \times \vert {a}_{τ , w} - {a}_{τ , e} \vert .$$

Wherein, e represents the image that needs to be queried. w represents the image in the dataset. S(fₑ,f_{w}) represents the scoring function. fₑ represents the features of image e. f_{w} represents the feature of image w. τ is the key point or head posture. α_{τ} is determined by comparing experimental results. a represents the nature of the face. a_{τ,w} represents the nature of face corresponding to the image retrieved from the dataset. α_{τ,e} represents the nature of face extracted from the retrieved image.

Then, in the process of replacing the glasses region having gaze direction truth labels, a gaze replacement method is designed to generate a synthetic facial image f_{w}′ with a true value gaze direction label g′. By affine transformation, the gaze direction truth attribute of fₑₛ may be retained.

In the process of constructing data, the present disclosure adopts 24,282 faces in the Widerface training set for gaze replacement, while other faces that are too small, too blurry, or have too many facial occlusions do not undergo gaze replacement. Compared with other known gaze datasets, the advantage of the newly proposed composite dataset lies in that each image contains one or more character objects, and the entire training set contains about 20,000 character objects. Besides, it has the advantage of a face detection dataset, which means that its data collection environment is very diverse.

Although the specific implementations of the present disclosure have been described above to facilitate the understanding of the present disclosure by those ordinarily skilled in the art, it should be clear that the present disclosure is not limited to the scope of specific implementations. For those ordinarily skilled in the art, as long as various changes are within the spirit and scope of the present disclosure as defined and determined by the attached claims, these changes are obvious, and all inventions and creations that utilize the concept of the present disclosure are under protection.

1. A method for estimating gaze directions of multiple persons in images, comprising:
obtaining a facial image, wherein the facial image comprises at least one face region;
constructing a deep network model for multi-task learning, wherein the deep network model comprises a plurality of multi-task processing structures capable of parallel calculations, the plurality of multi-task processing structures capable of parallel calculations output a gaze direction of each face region and face position information of each face region in the facial image through one-time calculation;
training the deep network model end-to-end on a dataset to obtain a trained deep network model, wherein the trained deep network model is used to determine the gaze directions of multiple persons; and
inputting the facial image to the trained deep network model to obtain the gaze direction of at least one face region included in the facial image.

2. The method of claim 1, wherein the face region in the at least one face region comprises at least one of the following: facial size information, posture information, facial expression information, and gender information.

3. The method of claim 2, wherein the deep network model is a multi-task single-stage deep network model, the deep network model comprising one encoder and multiple decoders, wherein, decoders in the multiple decoders are decoders that simultaneously complete different types of tasks, the deep network model is used to determine at the same time the gaze directions of multiple face regions, and output the face position information and key point information of multiple face regions.

4. The method of claim 3, wherein the method further comprises:
for the gaze direction of each face region in the gaze direction of the at least one face region, the following determination steps are performed:
determine positions y_{F},y_{T},y_{S} of gaze projection points of the gaze direction y_{g}=(θ,ψ) of the face region on front, top and side projection planes, wherein, y_{F} represents a position of a gaze projection point in a front direction, y_{T} represents a position of the gaze projection point in a top direction, y_{S} represents a position of the gaze projection point in a side direction, F represents the front direction, T represents the top direction, S represents the side direction, y_{y} represents the gaze direction of the face region, θ represents an angle of nutation in the gaze direction, and ψ represents an angle of rotation in the gaze direction;
determine whether the positions y_{F},y_{T},y_{S} of the gaze projection points on the front, top and side projection planes are equal to three projections of three-dimensional gaze prediction values, wherein, the three projections of the three-dimensional gaze prediction values are obtained by the following formula:
$$\{ \begin{matrix}{\prod }_{F} ( θ , ϕ ) = [ sin ϕcosθ , sin θ ] \\ {\prod }_{T} ( θ , ϕ ) = [ cos ϕcosθ , sin ϕcosθ ] \\ {\prod }_{S} ( θ , ϕ ) = [ cos ϕcosθ , sin θ ]\end{matrix} ,$$
wherein, Π represents a projection function, F represents the front direction, θ represents the angle of nutation in the gaze direction, ϕ represents the angle of rotation in the gaze direction, Π_{F}(θ,ϕ) represents projecting the gaze direction onto the front plane, sin ϕ represents a sine value of 0, cos θ represents a cosine value of θ, T represents the top direction, Π_{T}(0,ϕ) represents projecting the gaze direction onto the top plane, cos ϕ represents a cosine value of ϕ, S represents the side direction, Π_{S}(θ,ϕ) represents projecting the gaze direction onto the side plane, sin θ represents a sine value of θ.

5. The method of claim 4, wherein the deep network model comprises a self-supervised loss function, the self-supervised loss function is obtained by the following formula:
$${L}_{self} = {\sum }_{τ ∈ \{ F , T , S \}} {\vert {y}_{τ} - {\prod }_{τ} ( {y}_{g} ) \vert}_{1} \times {e}_{τ}^{- p} + {p}_{τ} ,$$
wherein, L_{self} represents the self-supervised loss function, τ represents the front or top or side direction, τ takes a value of {F,T,S}, F represents the front direction, T represents the top direction, S represents the side direction, y_{τ} represents the gaze direction in the front or top or side direction, Π represents the projection function, y_{g} represents the gaze direction of the face region, Π_{τ}(y_{g}) represents a projection function from three-dimension to two-dimension, ∥₁ represents a L1 norm, e represents a natural constant, p represents a trainable parameter, e_{τ}^{-p} represents a −p power of e, p_{τ} represents a correction coefficient for τ projection.

6. The method of claim 5, wherein the dataset is generated by a multi-person gaze direction image and generation framework that has replaced an eye region, by inputting two types of data, wherein, one type of data is single-person image data with a gaze direction label, and the other type of data is multi-person image data with multiple face regions, the generation framework is used to automatically cluster the single-person image data based on at least one of the gender information, race information, age information and head posture information, for easy retrieval, and the generation framework is also used to retrieve in the single-person image data, a single-person image data that is closest to the face region, for each face region in the multi-person image data, and replace the eye region, to generate a corresponding gaze direction.

7. The method of claim 6, wherein an overall loss function during end-to-end training process is obtained by the following formula:
$$L = α {L}_{face} + β {L}_{gaze} ,$$
wherein, L represents the overall loss function, α represents a first adjustable hyperparameter, L_{face} represents a loss function related to the face position information and key point information, β represents a second adjustable hyperparameter, L_{gaze} represents a loss function related to the gaze direction, wherein, L_{gaze} is obtained by the following formula:
$${L}_{gaze} = {λ}_{1} {L}_{self} + {λ}_{2} {\vert {y}_{g} - {y}_{g}^{*} \vert}_{1} ,$$
wherein, L_{gaze} represents the loss function related to the gaze direction, λ₁ represents a first hyperparameter used to balance different loss terms, L_{self} represents the self-supervised loss function, λ₂ represents a second hyperparameter used to balance different loss terms, y_{g} represents the gaze direction of the face region, y_{g}* represents a truth label, and ∥₁ represents the L1 norm.

8. The method of claim 7, wherein in a deployment environment, the facial image is input in real-time to the trained deep network model, to obtain the gaze direction of at least one face region included in the facial image.
